(19) United States
(12) Patent Application Publication
(10) Pub. No.: US 2018/0121907 A1
(43) Pub. Date: May 3, 2018

(54) SYSTEMS AND METHODS FOR ENHANCED VERIFICATION OF NEW USERS TO A NETWORK BASED SERVICE

(71) Applicant: MasterCard International Incorporated, Purchase, NY (US)

(72) Inventors: John D. Chisholm, Ballwin, MO (US); Johan Gerber, Wildwood, MO (US); Edgar AguilarGuido, Chesterfield, MO (US); Sanjay Challani, East Windsor, NJ (US); Vincent Walsh, Goalstown (IE)

(21) Appl. No.: 15/335,906

(22) Filed: Oct. 27, 2016

(51) Int. Cl. G06Q 20/36; H04L 29/06

(52) U.S. Cl. CPC G06Q 20/3674; H04L 63/166

(57) ABSTRACT

A computer-based method for verifying a new user during enrollment to a digital wallet application is provided. The method is implemented using a digital wallet computing device including one or more processors in communication with one or more memory devices. The method includes receiving, from the new user, an enrollment request to the digital wallet application. The enrollment request including attribute data associated with the new user. Calculating an authentication level of the enrollment request based on the attribute data, wherein the authentication level represents a level of confidence that the enrollment request is not fraudulent. The method also includes performing a lookup in the one or more member devices and retrieving an enrollment procedure from a plurality of enrollment procedures for the new user based on the calculated authentication level, and transmitting the enrollment procedure to the new user.

### BACKGROUND OF THE DISCLOSURE

This disclosure relates generally to enhancing fraud protection and, more particularly, to systems and methods for enhanced verification of new users to a network based service.

Phishing attacks may be used by parties interested in fraud as an attempt to gain personal and sensitive information of targets such as usernames, passwords, financial information, social security and identity information, and other information of the like. Some common and known phishing attacks are “spear phishing” attacks that are directed at specific individuals or corporations. Often the fraudulent party masquerades as a known entity to gain information from the target(s). If the party can gather some personal information and include the information about the target in the spear phishing attack then the likelihood of a successful attack is increased.

For example, a user has an existing relationship to a service provider, but would like to register for a network based service. As such, during an online registration process to the network based service, the user enters identification information, such as an email address and/or phone number, so the network based service may direct the user to the service provider and its website to complete registration. The network based service would like to simplify registration procedure and make this process as automatic, quick, and seamless as possible. Thus, the network based service automatically directs the user to the website of the service provider to complete the registration. However, this automatic direction to the service provider website also discloses personal information of the user, e.g. the relationship between the user and the service provided. If a fraudulent party knows the user's identification information, the fraudulent party may use the registration process to obtain the user's relationship to the service provider and exploit this knowledge for spear phishing attacks. The fraudulent party may then generate a personalized spear phishing attack for the user based on the service provider information in order to gain further information about the user.

Moreover, the user when further accessing the network based service, for example, through a new device, is required to enter personal identification information to complete access. To simplify the access procedure, the network based service may also automatically direct the user to the website of the service provider to complete the registration. However, this automatic direction may further disclose personal information of the user and increase the risk of undesirable information being provided and increase the risk of spear phishing attacks.

In another example, electronic transaction cards are widely used in the United States and elsewhere as a means to attach financial accounts to financial institutions and, in the case of credit cards, as a medium to create small loans and generate interest income for financial institutions. A user of the transaction card, known as a cardholder, can initiate an electronic transaction to purchase goods and/or services from a merchant. The merchant processes these transactions using a point-of-sale (POS) device or via a website that captures certain transaction information and communicates this information over a payment network to a merchant bank and ultimately to an issuer bank. Data is then exchanged between these parties over the payment network until the transaction is settled.

Some payment networks include network based services, such as digital wallet services, that enable cardholders of participating issuers to simplify electronic transactions with participating merchants. For example, cardholders may create a digital wallet account within the payment network by entering transaction card information and shipping information to the account. As such, cardholders may initiate online, in-app, and/or in-store purchases solely through the digital wallet account, for example via a smartphone, to make a purchase and transact with the merchant. By using the digital wallet account, cardholders do not have to fill out online-checkout forms, remember multiple passwords, or physically fumble for the transaction card.

However, some known digital wallet services are vulnerable to data attacks when cardholders are registered as new users. When cardholders are registered to the service there is the possibility that the identity of the issuing bank of the cardholder may inadvertently be disclosed to a fraudulent party. As such, the cardholder is vulnerable to spear phishing attacks. For example, a cardholder is shopping at a merchant website and selects paying with the digital wallet service before the cardholder is enrolled into the service. Before initiating a transaction with the merchant, the enrolling cardholder is automatically directed to a webpage for the digital wallet service, wherein the cardholder is prompted to enter attribute information to create an account for the digital wallet service. The digital wallet service compares the information provided by the cardholder to a registry of participating issuers. If the information provided, such as email account and/or phone number, by the cardholder matches a participating issuer, the cardholder is automatically directed to the issuer's website to complete registration and create an account with the digital wallet service. The webpage that the cardholder provides information on may be used by fraudulent parties and gain information of the cardholder for spear phishing attacks. For example, the fraudulent party may access cardholder information, such as the issuing bank, by knowing email account and/or phone number information. With such access, targeted spear phishing attacks may occur by the fraudulent party by generating emails directed to the cardholder masquerading as the issuing bank to gain more financial information. Furthermore, cardholders are more prone to spear phishing attacks if the attacks contain information about the issuing bank.

Moreover, the cardholder when further accessing the digital wallet service, for example, through a new device, is required to enter identification information to complete access. To simplify the access procedure, the digital wallet service may also automatically direct the user to the website of the service provider to complete the registration. However, this automatic direction may further disclose personal information of the user and increase the risk of undesirable information being provided and increase the risk of spear phishing attacks.

Accordingly, a system and method is needed that provides a authentication based evaluation and a verification service for the automatic enrollment procedure of digital wallet services.

BRIEF DESCRIPTION OF THE DISCLOSURE

In one embodiment, a computing device for verifying a new user during enrollment to a digital wallet application is provided. The digital wallet computing device includes one or more processors in communication with one or more memory devices. The one or more processors is configured to receive, from the new user, an enrollment request to the digital wallet application, the enrollment request including attribute data associated with the new user; calculate an authentication level of the enrollment request based on the attribute data, wherein the authentication level represents a level of confidence that the enrollment request is not fraudulent; perform a lookup in said one or more memory devices and retrieve an enrollment procedure from a plurality of enrollment procedures for the new user based on the calculated authentication level; and transmit the enrollment procedure to the new user.

In another aspect, a computer-implemented method for verifying a new user during enrollment to a digital wallet application is provided. The digital wallet application includes a computing device including one or more processors in communication with one or more memory devices. The method comprising: receiving, from the new user, an enrollment request to the digital wallet application, the enrollment request including attribute data associated with the new user; calculating an authentication level of the enrollment request based on the attribute data, wherein the authentication level represents a level of confidence that the enrollment request is not fraudulent; performing a lookup in the one or more memory devices and retrieving an enrollment procedure from a plurality of enrollment procedures for the new user based on the calculated authentication level; and transmitting the enrollment procedure to the new user.

In a further aspect, a non-transitory computer readable medium that includes computer executable instructions for verifying a new user during enrollment to a digital wallet application is provided. The digital wallet application includes a computing device comprising one or more processors in communication with one or more memory devices, wherein when executed the computer executable instructions cause the computing device to: receive, from the new user, an enrollment request to the digital wallet application, the enrollment request including attribute data associated with the new user; calculate an authentication level of the enrollment request based on the attribute data, wherein the authentication level represents a level of confidence that the enrollment request is not fraudulent; perform a lookup in the one or more memory devices and retrieve an enrollment procedure from a plurality of enrollment procedures for the new user based on the calculated authentication level; and transmit the enrollment procedure to the new user.

### BRIEF DESCRIPTION OF THE DRAWINGS

FIGS. 1-7 show exemplary embodiments of the methods and systems described herein.

FIG. 1 is a schematic diagram illustrating a multi-party payment system for processing payment transactions using a payment card or payment account in accordance with one embodiment of the present disclosure.

FIG. 2 is a block diagram of an exemplary embodiment of a system for verifying a new user cardholder during enrollment to a digital wallet application.

FIG. 3 illustrates an exemplary configuration of a client system shown in FIG. 2, in accordance with one embodiment of the present disclosure.

FIG. 4 illustrates an exemplary configuration of a server system shown in FIG. 2, in accordance with one embodiment of the present disclosure.

FIG. 5 illustrates a data flow diagram of an exemplary authentication-based decisioning process for the system shown in FIG. 2, in accordance with one embodiment of the present disclosure.

FIG. 6 is a flowchart illustrating an exemplary method for verifying a new user cardholder during enrollment to a digital wallet application using the system shown in FIG. 2.

FIG. 7 is a diagram of components of one or more exemplary computing devices that may be used in the system shown in FIG. 2.

### DETAILED DESCRIPTION OF THE DISCLOSURE

The methods and systems described herein relate to an electronic transaction card payment system, such as a credit card payment system using the MasterCard® interchange network (MasterCard is a registered trademark of MasterCard International Incorporated located in Purchase, N.Y.). The MasterCard® interchange network is a proprietary communications standard promulgated by MasterCard International Incorporated® for the exchange of electronic transaction data between financial institutions that have registered with MasterCard International Incorporated®. Additionally, the methods and system described herein relate to the regulation and use of a digital wallet application and payment application such as MasterCard International Incorporated MasterPass® system.

The embodiments described herein are directed to systems and methods for verifying a new user during an enrollment process and/or access login to a digital wallet application that may be used in combination with an electronic payment card processing system. The new user submits an enrollment request or access login, including attribute data associated with the new user, to the digital wallet application.

Upon receiving the enrollment request, the digital wallet application calculates an authentication level of the enrollment request based on the attribute data. The digital wallet application then determines the enrollment procedure for the new user based on the calculated authentication level, and transmits the enrollment procedure to the new user. For example, if the authentication level for fraudulent activity is low, the new user may be automatically directed to an issuer's website to complete the enrollment procedure and be provided a streamlined enrollment experience. However, if the authentication level for fraudulent activity is high, the new user may be prompted to select the issuer's website to be directed to and complete the enrollment procedure. This more disruptive experience, forces the new user to manually complete more steps in the enrollment process to reduce the risk of fraud.

Typically, an electronic transaction is performed by a user of a payment card. These users are referred to as cardholders. A cardholder is issued a payment card by an issuer or an issuing bank. The cardholder is able to use the payment card at participating merchants to initiate transactions. The merchant processes these transactions using a point-of-sale (POS) device that captures certain transaction information and communicates this information over a payment network to a merchant bank and ultimately to the issuer. Information is then exchanged between these parties over the payment network until the transaction is completed and/or settled.

During an online transaction between, for example, a cardholder and a merchant via the merchant's website that includes the digital wallet application, the merchant may offer to transact through the digital wallet application. For a cardholder shopping online, who is not enrolled in the digital wallet application, and selects the digital wallet application transaction, the cardholder is directed out of the merchant's website to an authentication webpage of the digital wallet application to initiate an enrollment process and complete the transaction with the merchant. From this authentication webpage, the cardholder inputs and/or provides attribute data and the digital wallet application determines if the new user cardholder is a trusted entity or not, such that a predetermined enrollment procedure is determined.

Additionally, when further accessing the digital wallet application, for example, through a new device, the cardholder is required to enter identification information to complete access and enroll the device. During this process, the cardholder similarly is directed to an authentication webpage of the digital wallet application to initiate the access process. From this authentication webpage, the cardholder inputs and/or provides attribute data and the digital wallet application determines if the new user cardholder is a trusted entity or not, such that a predetermined enrollment procedure is determined.

At the authentication webpage of the digital wallet application, the attribute data includes a plurality of data elements, for example, but not limited to, user attributes, device attributes, and behavioral metrics about the new user cardholder that the digital wallet application stores. For example, the new user cardholder may input attribute data, such as user attributes like an email address and/or phone number associated with the transaction card, to send to the digital wallet application and initiate enrollment therein. Additionally, when the enrollment request is submitted by the new user cardholder, the request and the attribute data further includes attributes from a computing device that the new user cardholder used to connect to the authentication webpage and submit the enrollment request. User computing device attributes may include device attribute data collected from the authentication webpage (e.g., data derived from the computing device using JavaScript that the cardholder is transacting from, which can be used for creating a device fingerprint, and which may include IP address, physical address associated with IP address, device type, operating system type, browser type, mobile request, language preference, phone number, and the like), request attribute data (e.g., cookies, Hypertext Transfer Protocol (HTTP) addresses and headers, and the like), and geo-location data (e.g., data from the device of the cardholder indicating the physical location of the device, such as GPS, country location, city location, and the like). From this information that is provided with the enrollment request, the digital wallet application determines a unique identifier, which is based on a hashing algorithm, for the user computing device and stores the unique identifier therein.

Based on the unique identifier and the user attributes, the digital wallet application calculates an authentication level of the enrollment request, such that the authentication level represents a level of confidence that the enrollment request is not fraudulent. In the exemplary embodiment, calculating the authentication level includes applying a plurality of calculations and fraud rules to determine the level of confidence in the new user cardholder, for example, determining behavior and fraud patterns based on analytical algorithms. In some embodiments, the digital wallet application compares the received computing device data via the unique identifier to a historical fraud information database to determine any matches that will correspond to a higher probability of fraud from the user device. For example, if the enrollment request is generated from a user computing device outside of the new user cardholder's home country and in a country known for fraudulent activity, then the level of confidence may be low. In other embodiments, the digital wallet application may use a variety of fraud scoring algorithms based on the received computing device data via the unique identifier to determine an authentication level. In yet other embodiments, the digital wallet application may use the unique identifier to determine the number of registration and/or login attempts from the user computing device to determine an authentication level. As such, the digital wallet application calculates an authentication level score to assist the digital wallet application in determining the enrollment procedure of the new user cardholder. In the exemplary embodiment, the authentication level score is a numerical value that is broken down into different ranges, wherein each range have a different meaning, for example, the new user cardholder may be “trusted,” “not trusted,” or “don't know enough to trust.”

In addition to the authentication level score, the digital wallet application may also generate one or more reason codes for the authentication level score. The reason codes represent reason why the digital wallet application calculated the authentication level score at that value. For example, one of the reason codes may be that the unique identifier matches a trusted computing device without any fraud use.

From the calculated authentication level of the new user cardholder, the digital wallet application then selects which enrollment procedure the new user cardholder will experience. If the authentication level is calculated to be “trusted,” then the new user cardholder enrollment procedure may be streamlined. For example, the new user cardholder will automatically be directed to the issuer's website, based on the supplied user attributes, where enrollment into the digital wallet application may be completed. However, if the authentication level is calculated to be “not trusted” and/or “don't know enough to trust,” then the new user cardholder may be presented with an authentication challenge, also known as a “step-up challenge.” In certain embodiments, the authentication challenge requires the new user cardholder to identify the issuer of the payment card before being directed to the issuer's website to complete enrollment into the digital wallet application. By obtaining this additional factor from the new user cardholder, the likelihood of the new user cardholder being a fraudulent user is reduced and information about issuing banks are not automatically exposed by the digital wallet system.

In some embodiments, the outcome of the step-up challenge is feed back into the authentication level calculation by the digital wallet system. In other embodiments, merchant data and fraud information are also included in the authentication level calculation by the digital wallet system. Additionally, cardholder information may be included in the authentication level calculation by the digital wallet system.

The methods and systems described herein may be implemented using computer programming or engineering techniques including computer software, firmware, hardware or any combination or subset thereof, wherein the technical effect is achieved by performing at least one of: (a) receiving, from the new user, an enrollment request to the digital wallet application, the enrollment request including attribute data associated with the new user; (b) calculating an authentication level of the enrollment request based on the attribute data, wherein the authentication level represents a level of confidence that the enrollment request is not fraudulent; (c) performing a lookup in the one or more memory devices and retrieving an enrollment procedure from a plurality of enrollment procedures for the new user based on the calculated authentication level; and (d) transmitting the enrollment procedure to the new user.

The systems and methods described herein provide the technical advantages of at least one of: (a) reducing automatic disclosure of an issuing bank based on cardholder information such as email address and/or phone number; (b) reducing spear fishing attacks on cardholders because the issuing bank information is available; (c) providing a streamlined digital wallet enrollment procedure for cardholders on trusted or low risk computing devices; (d) providing an enhanced digital wallet enrollment procedure for cardholder on non-trusted or high risk computing devices; and (e) increasing fraud protection for cardholders.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

The following detailed description illustrates embodiments of the disclosure by way of example and not by way of limitation. In addition, components of each system and each process can be practiced independent of and separate from other components and processes described herein. Each component and process also can be used in combination with other assembly packages and processes. It is contemplated that the disclosure has general application to processing electronic transaction data by a third party in industrial, commercial, and residential applications.

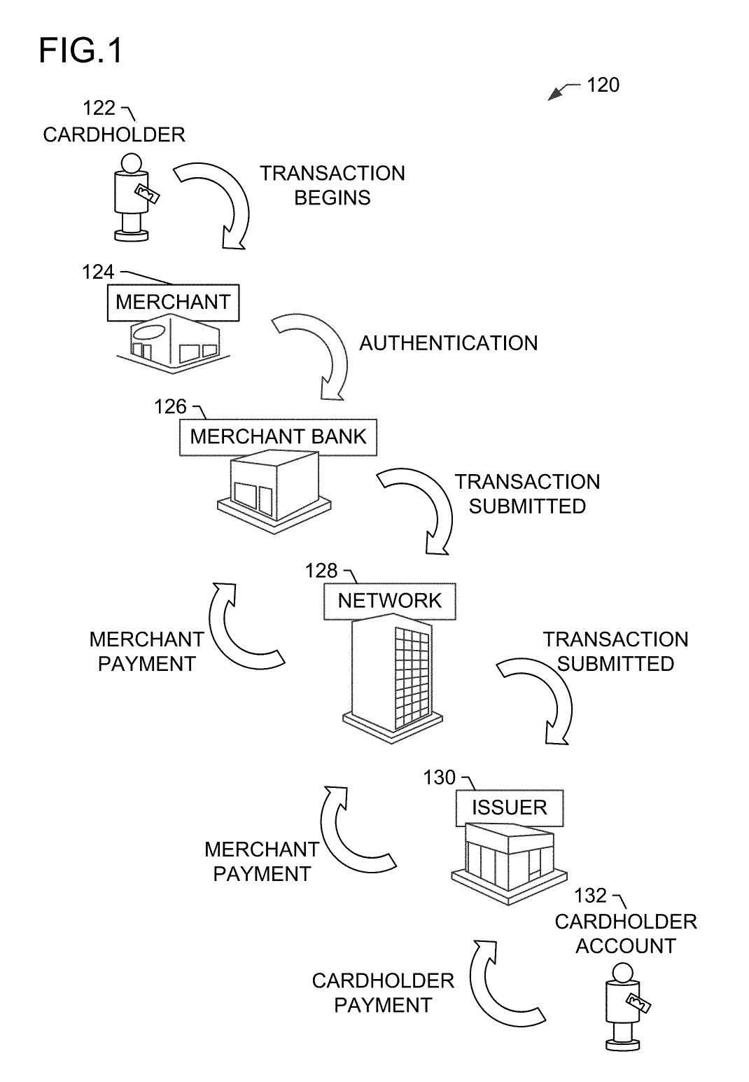

FIG. 1 is a schematic diagram illustrating an example multi-party payment processing system 120 for processing payment-by-card transactions between merchants 124 and cardholders 122. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data between financial institutions that are members of MasterCard International Incorporated®.

In a typical transaction card system, a financial institution, such as issuer 130, issues a transaction card or electronic payments account identifier, such as a credit card or a debit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank” or the “acquiring bank” or “acquirer.” In the example embodiment, when cardholder 122 tenders payment for a purchase with a transaction card, merchant 124 requests authorization from a merchant bank 126 for the amount of the purchase. The request may be performed over the telephone, but is usually performed through the use of a point-of-sale (POS) terminal, which reads cardholder's 122 account information from a magnetic stripe, a chip, embossed characters, or the like, included on the transaction card and communicates electronically with the transaction processing computers of merchant bank 126. Alternatively, merchant bank 126 may authorize a third party to perform transaction processing on its behalf In this case, the point-of-sale terminal will be configured to communicate with the third party. Such a third party is usually called a “merchant processor,” an “acquiring processor,” or a “third party processor.” Furthermore, in some embodiments, the payment card transaction is a card-not-present transaction conducted, for example, with a transaction card stored in a digital wallet.

Using an interchange network 128, the computers of merchant bank 126 or the merchant processor will communicate with the computers of issuer bank 130 to determine whether a cardholder's account 132 is in good standing and whether the purchase is covered by the cardholder's available credit line or account balance. Based on these determinations, the request for authorization will be declined or accepted. If the request is accepted, an authorization code may be issued to merchant 124.

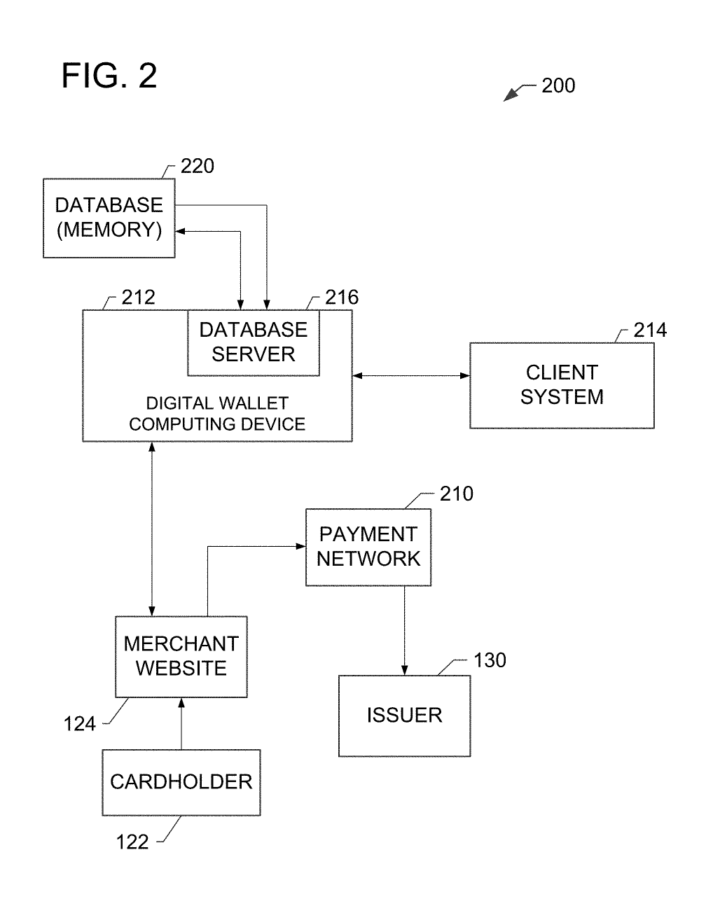

When a request for authorization is accepted, the available credit line or available balance of cardholder's account 132 is decreased. Normally, a charge is not posted immediately to a cardholder's account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If a cardholder cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

FIG. 2 is a block diagram of an exemplary embodiment of a system 200 for verifying a new user cardholder during enrollment to a digital wallet application. In the exemplary embodiment, system 200 may be used for performing payment-by-card transactions received as part of processing cardholder transactions. Furthermore, system 200 may be used to facilitate cardholder enrollment to a digital wallet application that is used for processing cardholder transactions. In addition, system 200 includes a digital wallet computing device 212, also known as a digital wallet application 212, configured to verify new user cardholder during enrollment to the digital wallet application. As described below in more detail, digital wallet computing device 212 is configured to receive an enrollment request from a cardholder 122 without a digital wallet account that is attempting to pay through a digital wallet at merchant 124. Digital wallet computing device 212 calculates an authentication level of the enrollment request based on attribute data provided by cardholder 122. Digital wallet computing device 212 is further configured to select an enrollment procedure for cardholder 122 and transmit the enrollment procedure to cardholder 122.

In the exemplary embodiment, client systems 214 are specially programmed computers that include a web browser or a software application to enable client systems 214 to access digital wallet computing device 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, a smart watch, or other web-based connectable equipment. In the example embodiment, cardholder 122 uses a client system 214 to access a commerce website for merchant 124.

A database server 216 is communicatively coupled to a database 220 that stores data. In one embodiment, database 220 includes attribute data, enrollment request messages, risk level scores, unique device identifiers, fraud rules, and fraud information. In the example embodiment, database 220 is stored remotely from digital wallet computing device 212. In some embodiments, database 220 is decentralized. In the example embodiment, a person can access database 220 via client systems 214 by logging onto digital wallet computing device 212, as described herein.

Digital wallet computing device 212 is communicatively coupled with payment network 210. Payment network 210 represents one or more parts of payment network 120 (shown in FIG. 1). In the example embodiment, digital wallet computing device 212 is in communication with one or more computer devices associated with interchange network 128 (shown in FIG. 1). In other embodiments, digital wallet computing device 212 is in communication with one or more computer devices associated with merchant bank 126 (shown in FIG. 1). In some embodiments, digital wallet computing device 212 may be associated with, or is part of payment network 120, or in communication with payment network 120, shown in FIG. 1. In other embodiments, digital wallet computing device 212 is associated with a third party and is in communication with payment network 120. In some embodiments, digital wallet computing device 212 may be associated with, or be part of merchant bank 126, interchange network 128, and issuer bank 130. In addition, digital wallet computing device 212 is communicatively coupled with merchant 124. In the example embodiment, digital wallet computing device 212 is in communication with merchant 124 and client systems 214 via Application Programming Interface (API) calls. Through the API call, merchant 124 may transmit information to and receive information from digital wallet computing device 212.

In some embodiments, digital wallet computing device 212 may be associated with the financial transaction interchange network 128 and may be referred to as an interchange computer system. Digital wallet computing device 212 may be used for processing transaction data and analyzing for fraudulent transactions. In addition, at least one of client systems 214 may include a computer system associated with an issuer 130 of a transaction card. Accordingly, digital wallet computing device 212 and client systems 214 may be utilized to process transaction data relating to purchases a cardholder 122 makes utilizing a transaction card processed by interchange network 128 and issued by the associated issuer 130. At least one client system 214 may be associated with a user or a cardholder 122 seeking to register, enroll, access information, or process a transaction with at least one of interchange network 128, issuer 130, or merchant 124. In addition, client systems 214 may include point-of-sale (POS) devices associated with merchant 124 and used for processing payment transactions.

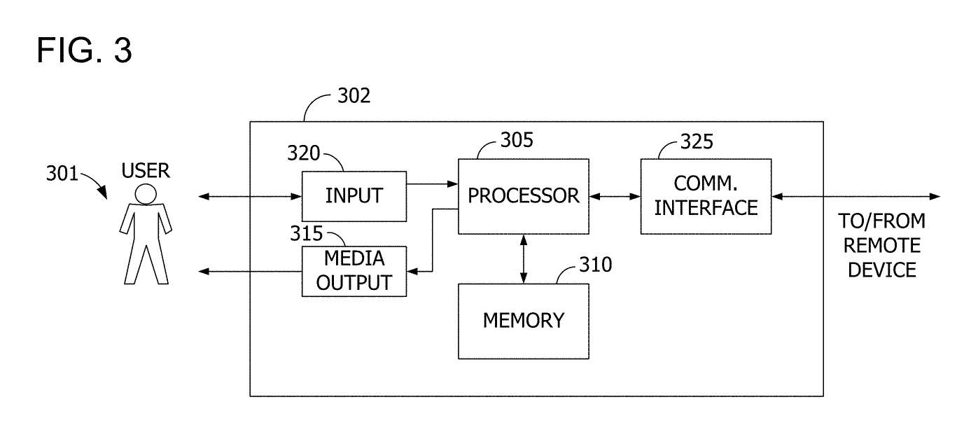

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214, computer devices associated with merchant 124, and computer devices associated with cardholder 122 (both shown in FIG. 1). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer-readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as digital wallet computing device 212 (shown in FIG. 2). Communication interface 325 may include, for example, a wired or wireless network adapter and/or a wireless data transceiver for use with a mobile telecommunications network.

Stored in memory area 310 are, for example, computer-readable instructions for providing a user interface to user 301 via media output component 315 and, optionally, receiving and processing input from input device 320. The user interface may include, among other possibilities, a web browser and/or a client application. Web browsers enable users, such as user 301, to display and interact with media and other information typically embedded on a web page or a website from digital wallet computing device 212. A client application allows user 301 to interact with, for example, digital wallet computing device 212. For example, instructions may be stored by a cloud service and the output of the execution of the instructions sent to the media output component 315.

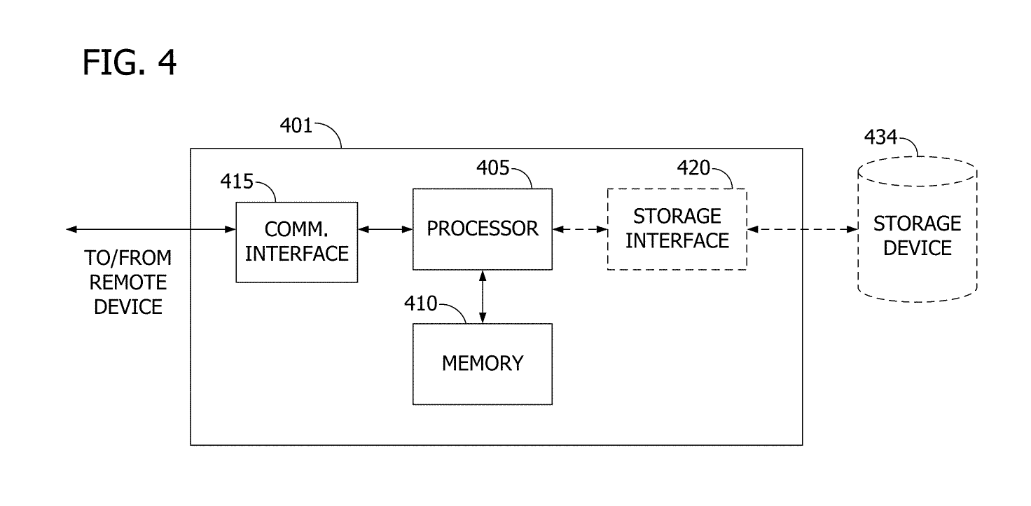

FIG. 4 illustrates an example configuration of a server system shown in FIG. 2, in accordance with one embodiment of the present disclosure. Server computer device 401 may include, but is not limited to, database server 216, merchant/website server 124, and digital wallet computing device 212 (all shown in FIG. 2). Server computer device 401 also includes a processor 405 for executing instructions. Instructions may be stored in a memory area 410. Processor 405 may include one or more processing units (e.g., in a multi-core configuration). The instructions may be executed within a variety of different operating systems, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages).

Processor 405 is operatively coupled to a communication interface 415 such that server computer device 401 is capable of communicating with a remote device such as another server computer device 401, client systems 214, merchant/website server 124, or digital wallet computing device 212 (all shown in FIG. 2). For example, communication interface 415 may receive requests from client systems 214 via the Internet.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

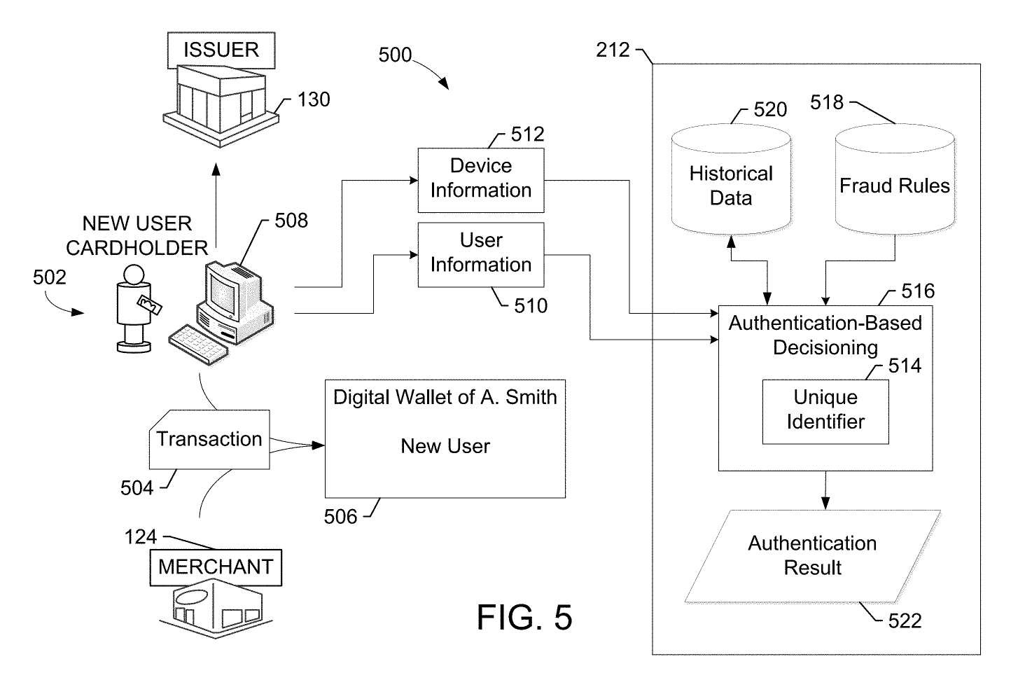

Processor 405 executes computer-executable instructions for implementing aspects of the disclosure. In some embodiments, processor 405 is transformed into a special purpose microprocessor by executing computer-executable instructions or by otherwise being programmed. For example, processor 405 is programmed with the instructions such as are illustrated in FIG. 5.

FIG. 5 illustrates a data flow diagram 500 of an exemplary risk-based decisioning process for system 200 (shown in FIG. 2). In some embodiments, process 500 operates on digital wallet computing device 212. In the exemplary embodiment, a new user cardholder 502 engages in a transaction 504 with merchant 124 using a digital wallet 506. For example, new user cardholder 502 may use a computing device 508 to login to a website of merchant 124 and select digital wallet 506 for use in completing transaction 504. However, new user cardholder 502 does not have an account and is not registered with a digital wallet application and thus new user cardholder 502 is directed through an enrollment procedure with digital wallet computing device 212. In another example, new user cardholder 502 is accessing or reregistering digital wallet 506 with a new computing device, such as computing device 508.

To begin enrollment with the digital wallet application, new user cardholder 502 inputs attribute data, such as user attributes, device attributes, and behavioral metrics, and submits the attribute data to digital wallet computing device 212. Attribute data may include user attributes 510, such as an email address and/or phone number associated with the transaction card, and computing device attributes 512 from computing device 508. Computing device attributes 512 may include device attribute data collected from the authentication webpage of digital wallet computing device 212 (e.g., data derived from computing device 508 using JavaScript that cardholder 502 is transacting from, which can be used for creating a device fingerprint, and which may include IP address, physical address associated with IP address, device type, operating system type, browser type, mobile request, language preference, phone number, and the like), request attribute data (e.g., cookies, Hypertext Transfer Protocol (HTTP) addresses, and the like), and geo-location data (e.g., data from computing device 508 of cardholder 502 indicating the physical location of the device, such as GPS, country location, city location, and the like).

In the exemplary embodiment, digital wallet computing device 212 receives the attribute data. From computing device attributes 512 a unique identifier 514 is determined for computing device 508 and stored in digital wallet computing device 212. Based on unique identifier 514 and user attributes 510, digital wallet computing device 212 may calculate an authentication level of the enrollment request, such that the authentication level represents a level of confidence that the enrollment request is not fraudulent. In the exemplary embodiment, authentication based decisioning 516 applies a plurality of fraud rules 518 to determine the level of confidence in new user cardholder 502. For example, digital wallet computing device 212 compares computing device data 512 via unique identifier 514 to historical fraud information data 520 to determine any matches that will correspond to a higher probability of fraud from computing device 508. As such, digital wallet computing device 212 determines an authentication result 522 of new user cardholder 502 and computing device 508. For example, authentication result 522 may be “trusted,” “not trusted,” or “don't know enough to trust.” In some embodiments, one or more reason codes the authentication result 522 may be generated.

From the calculated authentication result 522 of new user cardholder 502, digital wallet computing device 212 performs a lookup for the enrollment procedure for new user cardholder 502 and retrieves the enrollment procedure. In the exemplary embodiment, if authentication result 522 is calculated to be “trusted,” then the new user cardholder enrollment procedure may be streamlined. For example, new user cardholder 502 will automatically be directed to issuer 130, based on user attributes 510, wherein enrollment into the digital wallet application may be completed. However, if authentication result 522 is “not trusted” and/or “don't know enough to trust,” then new user cardholder 502 may be presented with a step-up challenge on computing device 508. For example, the step-up challenge requires new user cardholder 502 to identify issuer 130 of the transaction card before being directed to the issuer's website to complete enrollment into the digital wallet application. As such, digital wallet computing device 212 then has an additional indication of trust for new user cardholder 502 to facilitate sending cardholder 502 to the website of issuer 130 to complete enrollment into the digital wallet system. Additionally, issuing bank information is not automatically provided to higher risk enrollment requests to reduce cardholder information from being disseminated and reducing the likelihood of spear phishing attacks.

In some embodiments, the outcome of the step-up challenge is stored in historical data 520 and feed back into authentication based decisioning 516 by digital wallet computing device 212. In other embodiments, merchant data and fraud information are stored in historical data 520 and are also included into authentication based decisioning 516 by digital wallet computing device 212. Additionally, cardholder information may be stored in historical data 520 and included into authentication based decisioning 516 by digital wallet computing device.

In certain embodiments, user computing device 508 and digital wallet computing device 212 implement various security mechanisms to ensure that attribute data exchanged therebetween is secure. For example, in one embodiment, digital wallet computing device 212 implements at least one of a transport-level security mechanism and a message-level security mechanism to ensure the integrity and confidentiality of the attribute data sent between digital wallet computing device 212 and user computing device 508. Transport-level security mechanisms generally provide privacy and data integrity between two communicating computer applications and are characterized by at least one of a private connection between the computer applications via a TLS handshake protocol, identity authentication of the communicating parties using public-key cryptography, and the inclusion of a message integrity check using a message authentication code configured to prevent loss or alteration of data during transmission. Transport-level security mechanisms implemented by digital wallet computing device 212 and user computing device 508 include, without limitation, transport-level security mechanisms implemented using one of the Transport Layer Security (TLS) and Secure Sockets Layer (SSL) protocols. In contrast, message-level security mechanisms are applied to each message transmitted between communicating parties, for example, the enrollment request. More specifically, each message is secured individually and generally includes security-related information configured to permit access by an authenticated party. Examples of security-related information include, without limitation, digital signatures, digital certificates, and encryption/decryption keys. Accordingly, in certain embodiments, user computing device 508 and/or digital wallet computing device 212 applies one or more message-level security mechanisms to the attribute data and issuer information provided therebetween.

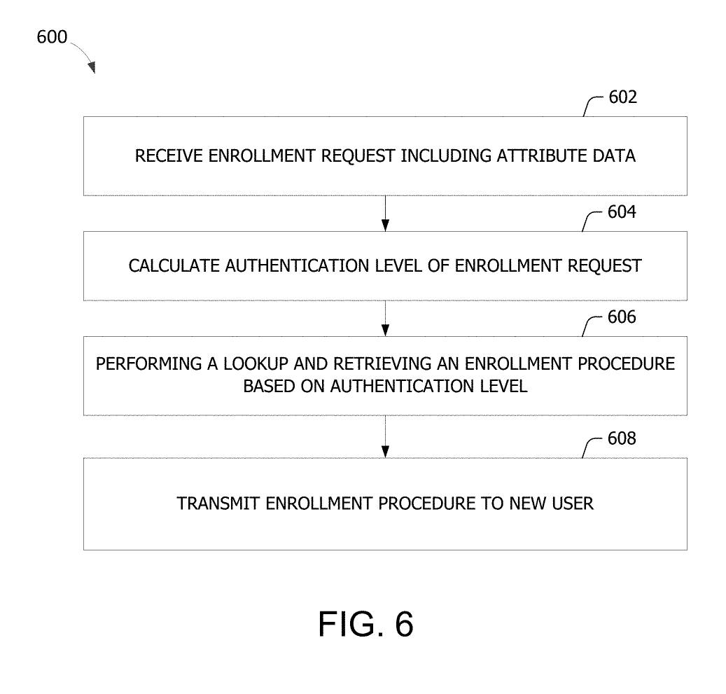

FIG. 6 is a flowchart illustrating an exemplary method 600 for verifying a new user cardholder during enrollment to a digital wallet application using system 200 (shown in FIG. 2). In the exemplary embodiment, method 600 is performed by digital wallet computing device 212 (shown in FIG. 2).

In the exemplary embodiment, digital wallet computing device 212 receives 602 an enrollment request to the digital wallet application from new user cardholder 502 (shown in FIG. 5). The enrollment request includes attribute data 510 and 512 (shown in FIG. 5) associated with new user cardholder 502. Digital wallet computing device 212 then calculates 604 an authentication level, such as authentication result 522 (shown in FIG. 5) based on the attribute data. In some embodiments, digital wallet computing device 212 determines a unique identifier 514 for cardholder's computing device 508 (both shown in FIG. 5) to calculate the authentication level from. In other embodiments, digital wallet computing device 212 applies at least one fraud rule, such as fraud rules 518 (shown in FIG. 5). For example, comparing the unique identifier to historical fraud data, such as historical fraud data 520 stored in digital wallet computing device 212 (shown in FIG. 5). As such, the authentication level may be “trusted,” “not trusted,” or “don't know enough to trust.”

From the authentication level, digital wallet computing device 212 performs 606 a lookup and retrieves an enrollment procedure for new user cardholder 502 and transmits 608 the enrollment procedure to new user cardholder 502. In the exemplary embodiment, if the authentication level is calculated to be “trusted,” then the new user cardholder enrollment procedure may be streamlined. For example, new user cardholder 502 will automatically be directed to issuer 130 (shown in FIG. 1) where enrollment into the digital wallet application may be completed. However, if the authentication level is “not trusted” and/or “don't know enough to trust,” then new user cardholder 502 may be presented with a step-up challenge. For example, the step-up challenge requires new user cardholder 502 to identify issuer 130 of the transaction card before being directed to the issuer's website to complete enrollment into the digital wallet application.

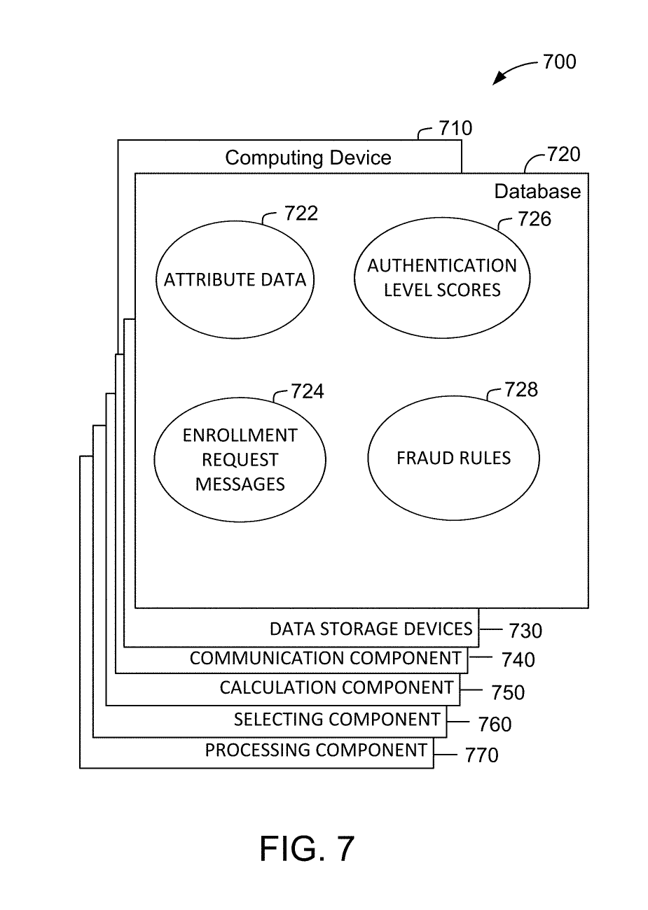

FIG. 7 is a diagram 700 of components of one or more example computing devices that may be used in system 200 (shown in FIG. 2). In some embodiments, computing device 710 is similar to digital wallet computing device 212 (shown in FIG. 2). Database 720 may be coupled with several separate components within computing device 710, which perform specific tasks. In this embodiment, database 720 includes attribute data 722, enrollment request messages 724, authentication level scores 726, and fraud rules 728. In some embodiments, database 720 is similar to database 220 (shown in FIG. 2).

Computing device 710 includes database 720, as well as data storage devices 730. Computing device 710 also includes a communication component 740 for receiving 602 an enrollment request message and transmitting 608 the enrollment procedure (both shown in FIG. 6). Computing device 710 also includes a calculating component 750 for calculating 604 the authentication level (shown in FIG. 6). Computing device 710 further includes a selecting component 760 for selecting 606 the enrollment procedure (shown in FIG. 6). A processing component 770 assists with execution of computer-executable instructions associated with the system.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the terms “card,” “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as vehicle computing devices, mobile phones, Smartphones, personal digital assistants (PDAs), key fobs, and/or computers. Each type of transaction card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads). The term “transaction card” or “payment card” can also refer to a bank account associated with a user or cardholder that is issued by an issuing bank whether or not a physical card is provided to the cardholder by the issuing bank.

Computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

Although the present disclosure is described in connection with an exemplary electronic transaction processing system environment, embodiments of the disclosure are operational with numerous other general purpose or special purpose electronic transaction processing system environments or configurations. The electronic transaction processing system environment is not intended to suggest any limitation as to the scope of use or functionality of any aspect of the disclosure. Moreover, the electronic transaction processing system environment should not be interpreted as having any dependency or requirement relating to any one or combination of components illustrated in the exemplary operating environment. Examples of well-known electronic transaction processing systems, environments, and/or configurations that may be suitable for use with the embodiments described herein include, but are not limited to, embedded computing devices, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal languages of the claims.

What is claimed is:

1. A computing device for verifying a new user during enrollment to a digital wallet application, said digital wallet computing device comprising one or more processors in communication with one or more memory devices, said one or more processors configured to:
receive, from a user device of the new user, an enrollment request to the digital wallet application, the enrollment request including attribute data associated with the new user;
calculate an authentication level of the enrollment request based on the attribute data, wherein the authentication level represents a level of confidence that the enrollment request is not fraudulent;
perform a lookup in said one or more memory devices and retrieving an enrollment procedure from a plurality of enrollment procedures for the new user based on the calculated authentication level; and
transmit the enrollment procedure to the new user to complete the enrollment request.

2. The computing device of claim 1, wherein the enrollment request from the new user applies at least one of a transport-level security mechanism and a message-level security mechanism to the attribute data,
wherein applying the transport-level security mechanism further includes at least one of establishing a private connection between the digital wallet application and the user device via a TLS handshake protocol, authenticating the user device using public-key cryptography, and performing a message integrity check using a message authentication code, and
wherein applying the message-level security mechanism includes transmitting at least one of a digital signature, a digital certificate, and an encryption key with the authentication data.

3. The computing device of claim 1, wherein the attribute data is based on attributes of the user device that the new user used to send the enrollment request.

4. The computing device of claim 1, wherein said one or more processors is further configured to determine a unique identifier for the user device that the new user used to send the enrollment request, wherein the unique identifier is based on the attribute data.

5. The computing device of claim 1, wherein said authentication level calculation comprises applying at least one fraud rule to the attribute data to determine a confidence level of the enrollment request.

6. The computing device of claim 5, wherein the at least one fraud rule for determining the confidence level of the enrollment request comprises comparing the attribute data to a fraud information database to determine any matches.

7. The computing device of claim 1, wherein the plurality of enrollment procedures comprises a streamlined enrollment procedure and a step-up challenge enrollment procedure.

8. The computing device of claim 7, wherein during the streamlined enrollment procedure the one or more processors is further configured to automatically direct the new user to an issuer website to complete enrollment in the digital wallet application.

9. The digital wallet computing device of claim 7, wherein during the step-up challenge enrollment procedure the one or more processors is further configured to:
obtain an issuer identification selection from the new user; and
direct the new user to an issuer website based on the issuer identification selection to complete enrollment in the digital wallet application.

10. A computer-implemented method for verifying a new user during enrollment to a digital wallet application, the digital wallet application including a computing device comprising one or more processors in communication with one or more memory devices, said method comprising:
receiving, from the new user, an enrollment request to the digital wallet application, the enrollment request including attribute data associated with the new user;
calculating an authentication level of the enrollment request based on the attribute data, wherein the authentication level represents a level of confidence that the enrollment request is not fraudulent;
performing a lookup in the one or more memory devices and retrieving an enrollment procedure from a plurality of enrollment procedures for the new user based on the calculated authentication level; and
transmitting the enrollment procedure to the new user to complete the enrollment request.

11. The method of claim 10, wherein the attribute data is based on attributes of a user device that the new user used to send the enrollment request.

12. The method of claim 10 further comprising determining a unique identifier for a user device that the new user used to send the enrollment request, wherein the unique identifier is based on the authentication data.

13. The method of claim 10, wherein calculating the authentication level comprises applying at least one fraud rule to the attribute data to determine a confidence level of the enrollment request.

14. The method of claim 13, wherein the at least one fraud rule for determining the confidence level of the enrollment request comprises comparing the attribute data to a fraud information database to determine any matches.

15. The method of claim 10, wherein the plurality of enrollment procedures comprises a streamlined enrollment procedure and a step-up challenge enrollment procedure.

16. The method of claim 15, wherein the streamlined enrollment procedure comprises automatically directing the new user to an issuer website to complete enrollment in the digital wallet application.

17. The method of claim 15, wherein the step-up challenge enrollment procedure comprises:
obtaining, by the digital wallet computing device, an issuer identification selection from the new user; and
directing the new user to an issuer website based on the issuer identification selection to complete enrollment in the digital wallet application.

18. A non-transitory computer readable medium that includes computer executable instructions for verifying a new user during enrollment to a digital wallet application, the digital wallet application including a computing device comprising one or more processors in communication with one or more memory devices, wherein when executed the computer executable instructions cause the computing device to:
receive, from a user device of the new user, an enrollment request to the digital wallet application, the enrollment request including attribute data associated with the new user;
calculate an authentication level of the enrollment request based on the attribute data, wherein the authentication level represents a level of confidence that the enrollment request is not fraudulent;
perform a lookup in the one or more memory devices and retrieve an enrollment procedure from a plurality of enrollment procedures for the new user based on the calculated authentication level; and
transmit the enrollment procedure to the new user to complete the enrollment request.

19. The non-transitory computer readable medium of claim 18, wherein the attribute data is based on attributes of the user device that the new user used to send the enrollment request.

20. The non-transitory computer readable medium of claim 18, wherein the computer executable instructions cause the digital wallet computing device to determine a unique identifier for the user device that the new user used to send the enrollment request, wherein the unique identifier is based on the attribute data.

21. The non-transitory computer readable medium of claim 18, wherein the plurality of enrollment procedures comprises a streamlined enrollment procedure and a step-up challenge enrollment procedure.
